(19) United States
(12) Patent Application Publication
(10) Pub. No.: US 2017/0182754 A1
(43) Pub. Date: Jun. 29, 2017

(54) Water-Vapour Permeable Composite Parts

(71) Applicant: Covestro Deutschland AG, Leverkusen (DE)

(72) Inventors: Govert Woeste, Düsseldorf (DE); Guido Schoenell, Neuss (DE)

(21) Appl. No.: 15/325,344

(22) PCT Filed: Jul. 6, 2015
(86) PCT No.: PCT/EP2015/065284

§ 371 Date: Jan. 10, 2017

(30) Foreign Application Priority Data
Jul. 11, 2014 (EP) 14176656.8
Jan. 27, 2015 (EP) 15152636.5

(51) Int. Cl. B32B 27/40; E04B 1/62; E04D 5/06; B32B 27/08

(52) U.S. Cl. CPC B32B 27/40; B32B 27/08; E04B 1/625; E04D 5/06; B32B 2250/02; B32B 2250/24; B32B 2307/724; B32B 2419/06

(57) ABSTRACT

The invention relates to water-vapour permeable, flat composite parts consisting of at least two layers, at least one layer being made of a polyether-based thermoplastic polyurethane. The invention also relates to the use thereof.

The invention relates to water vapour-permeable flat composite components consisting of at least two layers, wherein at least one layer consists of a polyether-based thermoplastic polyurethane, and to the use thereof.

Thermoplastic polyurethane elastomers (TPUs) are of industrial significance, since they exhibit excellent mechanical properties and can be processed by thermoplastic means inexpensively. Through the use of different chemical formation components, it is possible to vary their mechanical properties over a wide range. Comprehensive descriptions of TPUs, and the properties and uses thereof, can be found in Kunststoffe 68 (1978), p. 819-825 and Kautschuk, Gummi, Kunststoffe 35 (1982), p. 568-584.

TPUs are formed from linear polyols, usually polyester or polyether polyols, organic diisocyanates and short-chain diols (chain extenders). The formation reaction can be accelerated by additionally adding catalysts. The molar ratios of the formation components can be varied over a wide range, which allows the properties of the product to be adjusted. According to the molar ratios of polyols to chain extenders, products are obtained over a wide Shore hardness range. The thermoplastically processible polyurethane elastomers can be formed either stepwise (prepolymer method) or through the simultaneous reaction of all the components in one stage (one-shot method). In the prepolymer method, the polyol and diisocyanate are used to form an isocyanate-containing prepolymer which is reacted in a second step with the chain extender. The TPUs can be prepared continuously or batchwise. The best-known industrial production methods are the belt method and the extruder method.

As well as catalysts, auxiliaries and additives can also be added to the TPU formation components.

Particularly in the textile industry and in the construction industry, TPUs are used in the form of extruded films. In conjunction with textile layers or web-like fabrics, they find use in weather-resistant items of clothing, tarpaulins, roofing underlayment or exterior underlayment (composite components). The task of the TPU here in each case is firstly to act as a barrier to water in liquid form (e.g. rain) and secondly to release water in the gaseous state from the interior to the exterior, in order to obtain the most pleasant interior conditions possible. In contrast to other materials, TPU can fulfil this double function without production of micropores in the TPU layer.

Factors of crucial significance, as well as good water vapour permeability of such composite components and hence of the TPU layer, are both minimum swelling and adequate mechanical properties of the TPU films used in the composite component. An excessive tendency of the TPU film to swell increases the risk that the TPU film will become detached from the other layers that form part of the composite (e.g. the web), also called the substructure. As a result of this detachment, the usually very thin TPU films are additionally exposed to the risk of damage in the form of cracks, for example. In addition, inadequate mechanical properties of the TPU films used not only make them more difficult to process to give the composite component, but likewise increase the risk of damage and lead to perceptible losses in the functionality of the composite components described.

To date, high demands in terms of water vapour permeability have been fulfilled using almost exclusively TPUs based on poly(tetrahydrofuran) (called C4 ether-based TPUs). These TPUs do have a good profile of properties, but they are based on comparatively costly raw materials.

Very high water vapour permeabilities are achieved with TPUs based exclusively on poly(ethylene glycol) (called C2 ether-based TPUs). However, these TPUs are not usable for roofing underlayment since they become detached very easily from the film substructure (for example from the nonwoven fabric) as a result of severe swelling. They are therefore preferably used in superabsorbents, as described, for example, in WO2000/039179.

EP-A 1366100 describes polyether-based TPUs in which the polyether polyol components have a random structure and contain more than 75% by weight of propylene oxide units. The polyether polyol components used, which are prepared in the presence of a double metal cyanide catalyst, have a high content of secondary hydroxyl groups of 51%-100% and molar masses of 600-1500 g/mol. These polyether polyol components reduce the phase separation between the TPU hard segment phase (formed from the isocyanate and the chain extender) and the TPU soft segment phase (formed from the polyol), as a result of which these TPU materials have inadequate water vapour permeability.

U.S. Pat. No. 4,202,957 describes TPUs formed from diphenylmethane 4,4′-diisocyanate, one to two chain extenders and block copolymers formed from polyoxyethylene and polyoxypropylene units, which are obtained by polymerization of ethylene oxide onto prepolymerized propylene oxide and have molar masses of 1000-3000 g/mol and a content of primary hydroxyl groups of at least 50%. In order to obtain the desired properties, especially an improved thermal stability of the TPUs, the ethylene oxide bridges of the block copolymers must exceed a particular minimum length. The minimum proportion of ethylene oxide units required for that purpose (EO %) is calculated from the formula EO %=(MW−900)/4*3*100/MW (with MW=molar mass of the block copolymer). The TPUs described are only of very limited usability for water vapour-permeable composite components because, according to the molar mass of the block copolymer used, they either have a high tendency to swell or a too low water vapour permeability.

EP-A 0881244 discloses a process for producing TPUs, wherein the reactivity of the polyol component and the profile of mechanical properties of the TPUs are improved by using polyether polyalcohols having polyoxyethylene and polyoxypropylene units having a high content of primary hydroxyl groups of 80%-100%. These are block copolymers of polyoxyethylene and polyoxypropylene units. The high content of primary hydroxyl groups is required to assure sufficient reactivity of the polyols toward isocyanates. The TPUs are comparatively costly as a result. In addition, they have a tendency to swell excessively.

In WO 2008/007046, active ingredient-containing polymers are prepared from a diisocyanate, a chain extender, a polyethylene glycol-polypropylene glycol-polyethylene glycol block copolymer or a polypropylene glycol-polyethylene glycol-polypropylene glycol block copolymer and polyethylene glycol or polypropylene glycol, where the release rate of the active ingredient present in the polymer is controlled via the composition of the polymer. The polymers having blocks of polyethylene glycol have a tendency to swell excessively.

EP-A 0748828 describes a process in which isocyanate components and one or more chain extenders are reacted with a polyoxyalkylene polyol comprising a polyoxypropylene component.

The polyoxyalkylene polyols are preferably polyoxypropylene/polyoxyethylene block copolymers having up to 30% by weight of oxyethylene units present in the form of a cap. The polyurethanes based on the block copolymers mentioned have a tendency to swell excessively.

The problem addressed was that of providing a flat composite component composed of at least two layers, of which at least one is based on TPU, wherein the TPU layer is based on comparatively inexpensive raw materials having sufficient reactivity for simple processibility to give TPU, and wherein the TPU layer simultaneously has a high water vapour permeability with simultaneously low swelling and adequate mechanical properties.

This problem was solved by using, as TPU layer, a TPU based on a mixture of polyether polyols, wherein a particular content of oxyethylene units is observed in this mixture and, in addition, a particular ratio between the TPU hard segment phase and the TPU soft segment phase, defined via the molar ratio of chain extender (component B) to polyol (component C), is established.

The invention provides water vapour-permeable flat composite components consisting of at least one layer (i) not consisting of thermoplastic polyurethane, at least one layer (ii) composed of polyether polyol-based thermoplastic polyurethane and optionally further layers (iii) composed of thermoplastic polyurethane that do not directly adjoin the layer (ii) with a flat join, where the layer (ii) consists of a thermoplastic polyurethane obtainable from the reaction of the components consisting of
A) at least one organic diisocyanate,
B) at least one component having in each case two hydroxyl groups and in each case a number-average molecular weight of 60 to 490 g/mol as chain extender,
C) a component consisting of one or more polyether polyols each having a number-average molecular weight of 500-5000 g/mol, of which at least one polyether polyol (C1) contains ethylene oxide units, in the presence of
D) optionally catalysts,
E) optionally assistants and/or additives, where the molar ratio of the NCO groups in A) to the isocyanate-reactive groups in B) and C) is 0.9:1 to 1.2:1,
   characterized in that the content of ethylene oxide units in component C) is at least 5% and not more than 42% by weight, preferably 5 to 35% by weight, based on the total weight of component C), and the number-average functionality of component C) is 1.8 to 2.5, and the content of ethylene oxide units (X in % by weight) in component C), relative to the molar ratio Y of chain extenders B) to component C), is below the value of X which arises from the formula X (% by weight)=7.7*Y+7.

The TPUs used in accordance with the invention in layer (ii) surprisingly have very good water vapour permeabilities with simultaneously extremely low swelling, and additionally have sufficiently good mechanical properties, such that it is possible to provide the inventive composite components.

Useful organic diisocyanates A) preferably include aliphatic, cycloaliphatic, araliphatic, heterocyclic and aromatic diisocyanates, as described in Justus Liebigs Annalen der Chemie, 562, p. 75-136.

Specific examples include: aliphatic diisocyanates such as hexamethylene 1,6-diisocyanate, cycloaliphatic diisocyanates such as isophorone diisocyanate, cyclohexane 1,4-diisocyanate, 1-methylcyclohexane 2,4-diisocyanate and 1-methylcyclohexane 2,6-diisocyanate and the corresponding isomer mixtures, dicyclohexylmethane 4,4′-diisocyanate, dicyclohexylmethane 2,4′-diisocyanate and dicyclohexylmethane 2,2′-diisocyanate and the corresponding isomer mixtures, aromatic diisocyanates such as tolylene 2,4-diisocyanate, mixtures of tolylene 2,4-diisocyanate and tolylene 2,6-diisocyanate, diphenylmethane 4,4′-diisocyanate, diphenylmethane 2,4′-diisocyanate and diphenylmethane 2,2′-diisocyanate, mixtures of diphenylmethane 2,4′-diisocyanate and diphenylmethane 4,4′-diisocyanate, urethane-modified liquid diphenylmethane 4,4′-diisocyanates and diphenylmethane 2,4′-diisocyanates, 4,4′-diisocyanato-1,2-diphenylethane and naphthylene 1,5-diisocyanate. Preference is given to using hexamethylene 1,6-diisocyanate, isophorone diisocyanate, dicyclohexylmethane 4,4′-diisocyanate, naphthylene 1,5-diisocyanate and diphenylmethane diisocyanate isomer mixtures having a diphenylmethane 4,4′-diisocyanate content of >96% by weight and especially diphenylmethane 4,4′-diisocyanate and hexamethylene 1,6-diisocyanate. These diisocyanates can be used individually or in the form of mixtures with one another. They can also be used together with up to 15% by weight (based on the total amount of diisocyanate) of a polyisocyanate, for example triphenylmethane 4,4′,4″-triisocyanate or polyphenylpolymethylene polyisocyanates.

Chain extenders B) used are one or more diols having a number-average molecular weight of 60 to 490 g/mol, preferably aliphatic diols having preferably 2 to 14 carbon atoms, for example ethanediol, propane-1,2-diol, propane-1,3-diol, butanediol, hexanediol, diethylene glycol, dipropylene glycol, especially aliphatic diols having preferably 2 to 8 carbon atoms, preferably butane-1,4-diol and hexane-1,6-diol. Also suitable, however, are diesters of terephthalic acid with glycols having 2 to 4 carbon atoms, for example ethylene glycol bisterephthalate or butane-1,4-diol bisterephthalate, hydroxyalkylene ethers of hydroquinone, for example 1,4-di(beta-hydroxyethyl)hydroquinone and ethoxylated bisphenols, for example 1,4-di(beta-hydroxyethyl)bisphenol A. It is also possible to use mixtures of the abovementioned chain extenders, especially two different, more preferably aliphatic, chain extenders, especially butane-1,4-diol and hexane-1,6-diol. In addition, it is also possible to add relatively small amounts of triols.

Suitable polyether polyols for component C) can be prepared by reacting one or more alkylene oxides having 2 to 4 carbon atoms in the alkylene radical with a starter molecule containing two active hydrogen atoms in bound form. Examples of alkylene oxide include: ethylene oxide, 1,2-propylene oxide, epichlorohydrin and 1,2-butylene oxide and 2,3-butylene oxide. The alkylene oxides can be used individually, in alternating succession or as mixtures. Examples of useful starter molecules include: water, amino alcohols such as N-alkyldiethanolamines, for example N-methyldiethanolamine, and diols such as ethylene glycol, 1,3-propylene glycol, butane-1,4-diol and hexane-1,6-diol. It is optionally also possible to use mixtures of starter molecules. Suitable polyether polyols are additionally the hydroxyl-containing polymerization products of propane-1,3-diol and tetrahydrofuran. It is also possible to use trifunctional polyethers, but at most in such an amount as to form a thermoplastically processible product and such that the number-average functionality of the sum total of all the polyether polyols in C) is 1.8 to 2.5. The preferably essentially linear polyether polyols have number-average molecular weights of 500 to 5000 g/mol. The polyether polyols can be used either individually or in the form of mixtures with one another. In a particularly preferred execution, the polyether polyol used is not a poly(tetramethylene glycol).

Component C) contains at least one polyether polyol C1) containing ethylene oxide units (—(O—CH₂—CH₂—)— units, also referred to as oxyethylene units). The content of ethylene oxide units in component C) is at least 5% and not more than 42% by weight, preferably 5% to 35% by weight, based on the total weight of component C), and the content of ethylene oxide units (X in % by weight) in component C), relative to the molar ratio Y of chain extenders B) to component C), is below the value of X which arises from the formula X (% by weight)=7.7*Y+7.

Preference is given to using, as polyether polyols C1) containing ethylene oxide units, aliphatic polyether polyols formed from ethylene oxide units and from propylene oxide units (—(O—CH(CH₃)—CH₂—)— and/or (—(O—CH₂—CH₂—CH₂—)— units, also referred to as oxypropylene units), the number-average molecular weights of which are preferably 1800 to 3000 g/mol. More particularly, the polyether polyols formed from ethylene oxide units and propylene oxide units used are those which contain 30% to 99% by weight of ethylene oxide units and 1% to 70% by weight of propylene oxide units, more preferably 35% to 99% by weight of ethylene oxide units and 1% to 65% by weight of propylene oxide units. In addition, particular preference is given to the polyether polyols which are formed from ethylene oxide units and propylene oxide units and have 1% to 75%, especially 50% to 75%, primary hydroxyl end groups. At least one of the polyether polyols C1) containing ethylene oxide units in component C) is preferably one or more components from the group consisting of poly(ethylene glycol), a copolymer of ethylene oxide units and 1,2-propylene oxide units, a copolymer of ethylene oxide units and 1,3-propylene oxide units, a copolymer of ethylene oxide units and 1,3-propylene oxide units and 1,2-propylene oxide units. In a particularly preferred execution, the polyether polyols C1) formed from ethylene oxide units and propylene oxide units are not in the form of block copolymers. The polyether polyols C1) formed from ethylene oxide units and propylene oxide units may be employed individually or else in the form of mixtures with one another or else in a mixture with one or more preferably aliphatic polyether polyols, preferably from the group consisting of poly(ethylene glycol), poly(1,2-propylene glycol) and poly(1,3-propylene glycol). In addition, it is also possible to use mixtures of poly(ethylene glycol) with one or more preferably aliphatic polyether polyols, preferably from the group consisting of poly(1,2-propylene glycol) and poly(1,3-propylene glycol).

Component C) is preferably a component mixture from the group consisting of poly(ethylene glycol) and poly(1,2-propylene glycol), of poly(ethylene glycol) and poly(1,3-propylene glycol), of poly(ethylene glycol) and poly(1,3-propylene glycol) and poly(1,2-propylene glycol), poly(ethylene glycol) and a polyol formed from ethylene oxide units and from propylene oxide units, of poly(1,2-propylene glycol) and a polyol formed from ethylene oxide units and from propylene oxide units, of poly(1,3-propylene glycol) and a polyol formed from ethylene oxide units and from propylene oxide units, of poly(ethylene glycol) and poly(1,2-propylene glycol) and a polyol formed from ethylene oxide units and from propylene oxide units, of poly(ethylene glycol) and poly(1,3-propylene glycol) and a polyol formed from ethylene oxide units and from propylene oxide units, of poly(ethylene glycol) and poly(1,3-propylene glycol) and poly(1,2-propylene glycol) and a polyol formed from ethylene oxide units and from propylene oxide units.

TPUs which contain component C) described in the preceding paragraphs have very good water vapour permeabilities with simultaneously extremely low swelling, and additionally have sufficiently good mechanical properties.

The molar ratio between the chain extender B) on the one hand and the polyols C) on the other hand is preferably 0.7:1 to 6.6:1.

Suitable catalysts D) for TPU production may be the customary tertiary amines known according to the prior art, for example triethylamine, dimethylcyclohexylamine, N-methylmorpholine, N,N′-dimethylpiperazine, 2-(dimethylaminoethoxy)ethanol, diazabicyclo[2.2.2]octane, and preferably organic metal compounds, for example titanic esters, iron compounds, tin compounds, for example tin diacetate, tin dioctoate, tin dilaurate or the dialkyltin salts of aliphatic carboxylic acids, for example dibutyltin diacetate, dibutyltin dilaurate. Particularly preferred catalysts are organic metal compounds, especially titanic esters, iron compounds or tin compounds.

As well as the TPU components and the catalysts, it is also possible to add other auxiliaries and/or additives E). Examples include silicone compounds, antiblocking agents, inhibitors, stabilizers against hydrolysis, light, heat and discolouration, flame retardants, dyes, pigments, inorganic or organic fillers and reinforcers. Reinforcers are especially fibrous reinforcing materials such as inorganic fibres, which are produced according to the prior art and may also be sized. Further details of the auxiliaries and additives mentioned can be found in the specialist literature, for example J. H. Saunders, K. C. Frisch: “High Polymers”, volume XVI, Polyurethanes, parts 1 and 2, Interscience Publishers 1962 and 1964, R. Gächter, H. Muller (eds.): Taschenbuch der Kunststoff-Additive [Handbook of Plastics Additives], 3rd edition, Hanser Verlag, Munich 1989, or DE-A 29 01 774.

Also suitable for incorporation are standard plasticizers such as phosphates, adipates, sebacates and alkylsulphonic esters.

It is likewise possible to use small amounts of customary monofunctional compounds as well, for example as chain terminators or demoulding aids. Examples include alcohols such as octanol and stearyl alcohol or amines such as butylamine and stearylamine.

For preparation of the TPUs in layer (ii), the formation components can be reacted, optionally in the presence of catalysts, auxiliaries and additives, in such amounts that the equivalents ratio of NCO groups to the sum total of the NCO-reactive groups, especially the OH groups of the low molecular weight diols/triols and polyether polyols, is 0.9:1.0 to 1.2:1.0, preferably 0.95:1.0 to 1.10:1.0.

Further water vapour-permeable layer(s) (i) used in the composite component are preferably layers of textiles, nonwovens, thermoplastic polymers, excluding thermoplastic polyurethane, for example polyethylene, polypropylene, fluorinated polyolefins, polyesters and polyamides, paper or cardboard or metal meshes. Water vapour-permeable layers are understood to mean both layers having mechanically produced holes through which the water vapour can penetrate and layers having intrinsic water vapour permeability. Particular preference is given to using nonwovens or textiles. The layers (i) may be disposed on one or both sides of the TPU layer (ii).

The TPUs used for the layer (ii) may be produced continuously in what is called an extruder method, for example in a multi-shaft extruder. The TPU components A), B) and C) can be metered in simultaneously, i.e. in a one-shot method, or successively, i.e. by a prepolymer method. The prepolymer can either be initially charged batchwise or produced continuously in a portion of the extruder or in a separate upstream prepolymer unit.

The TPUs used in the layer (ii) for production of the composite components according to the invention have good mechanical and elastic properties. In addition, they have excellent processibility.

The polyether polyol-based TPUs used can be used to produce films and foils and also coatings having great homogeneity from the melt as layer (ii). The composite components according to the invention can be used as roofing underlayment and exterior underlayment.

The invention is to be illustrated in more detail by the examples which follow.

### EXAMPLES

TPU Preparation

A reaction vessel was initially charged with 100 parts by weight of polyol with a temperature of 200° C., in which there had been dissolved 0.17 to 0.25 parts by weight of Irganox® 1010 (manufacturer: BASF SE, Ludwigshafen, DE). Then (see Table 1) 6.6 to 16 parts by weight of butane-1,4-diol (BDO), a sufficient number of parts by weight of diphenylmethane 4,4′-diisocyanate (MDI) at 60° C. that the index was 0.995 and 20 ppm of tin di(2-ethylhexanoate) and 0.3% by weight, based in each case on the total weight of all the feedstocks, of Licolub® FA6 wax (manufacturer: Clariant, Gersthofen, DE) were added while stirring, and the complete reaction mixture was stirred vigorously for 15 to 35 seconds. Subsequently, the viscous reaction mixture was poured onto a coated metal sheet and heat-treated at 80° C. for a further 30 minutes. The cast sheets obtained were cut and pelletized.

Raw Materials Used:
Polyol A Polyether L5050 (OH number: 55.9-56.7 mg KOH/g, 1,2-propylene glycol-started bifunctional polyether formed from ethylene oxide and propylene oxide with an ethylene oxide cap (about 10% by weight), an ethylene oxide content of about 50% by weight and with 60%-70% primary hydroxyl end groups); Bayer MaterialScience AG, Leverkusen, DE
Polyol B Acclaim® Polyol 2200 N (OH number: 56.1-56.7 mg KOH/g, poly(1,2-propylene glycol)); Bayer MaterialScience AG, Leverkusen, DE
Polyol C Terathane® 1000 (OH number: 113.4 mg KOH/g, poly(tetrahydrofuran)); BASF SE, Ludwigshafen, DE
Polyol D Terathane® 2000 (OH number: 56 mg KOH/g, poly(tetrahydrofuran)); BASF SE, Ludwigshafen, DE
Polyol E Polyether PW56 (OH number: 56.7 mg KOH/g, poly(ethylene glycol)); Bayer MaterialScience AG, Leverkusen, DE
Polyol F Polyether PW 100 (OH number: 107 mg KOH/g, poly(ethylene glycol)); Bayer MaterialScience AG, Leverkusen, DE
MDI Desmodur® 44 M (diphenylmethane 4,4′-diisocyanate); Bayer MaterialScience AG, Leverkusen, DE
BDO butane-1,4-diol; BASF SE, Ludwigshafen, DE

TABLE 1
Preparation of TPUs

| | | | Ethylene | | | | |
|---|---|---|---|---|---|---|---|
| | | | oxide | | | | |
| | | | groups in | | | | |
| | | | component | | Moles of | | Irganox ® |
| | | Polyol | C) [pts. by | BDO | BDO: moles | MDI | 1010 |
| TPU | Polyol | [pts. by wt.] | wt.] | [pts. by wt.] | of polyol | [pts. by wt.] | [pts. by wt.] |
| 1* | A | 100 | 50 | 10 | 2.18 | 40.2 | 0.25 |
| 2* | A | 100 | 50 | 16 | 3.53 | 56.9 | 0.19 |
| 3* | C | 100 | 0 | 11.1 | 1.21 | 55.6 | 0.25 |
| 4* | D | 100 | 0 | 10 | 2.21 | 40 | 0.25 |
| 5* | E | 100 | 100 | 10 | 2.18 | 40.1 | 0.17 |
| 6* | F | 100 | 100 | 11 | 1.27 | 54.1 | 0.17 |
| 7* | E | 40 | 40 | 10 | 2.20 | 40.1 | 0.21 |
| | B | 60 | | | | | |
| 8 | A | 40 | 20 | 10 | 2.20 | 40.1 | 0.21 |
| | B | 60 | | | | | |
| 9* | E | 20 | 20 | 10 | 2.20 | 39.9 | 0.21 |
| | B | 80 | | | | | |
| 10* | A | 50 | 25 | 10 | 2.19 | 40 | 0.23 |
| | B | 50 | | | | | |
| 11 | A | 50 | 25 | 13.4 | 2.95 | 49.7 | 0.23 |
| | B | 50 | | | | | |
| 12* | A | 60 | 30 | 11.6 | 2.57 | 44.4 | 0.21 |
| | B | 40 | | | | | |
| 13 | A | 40 | 20 | 9.4 | 2.08 | 38.5 | 0.22 |
| | B | 60 | | | | | |
| 14* | A | 60 | 30 | 13.4 | 2.97 | 49.5 | 0.20 |
| | B | 40 | | | | | |
| 15* | A | 50 | 25 | 10.6 | 2.32 | 41.4 | 0.22 |
| | B | 50 | | | | | |
| 16 | A | 50 | 25 | 11.6 | 2.56 | 44.7 | 0.21 |
| | B | 50 | | | | | |

*comparative examples

TPU Film Production

The pelletized TPU materials 1 to 16 were each melted in a single-shaft extruder (Brabender Plasticorder PL 2100-6 30/25D single-shaft extruder) (metering rate about 3 kg/h; 185-215° C.) and extruded through a slot die to give a flat film in each case.

Measurement of Water Vapour Permeability (WVP) of the Composite Component by Measuring the WVP of the TPU Films Used

The water vapour permeability (WVP) of the films produced was determined in a method based on DIN 53122. For this purpose, the films were stretched and fixed over a 50 ml or 100 ml vessel (diameter 46.5 mm). The vessel had been charged beforehand with 40 g of silica gel granules (diameter 1-3 mm, with indicator) which had been baked at 130° C. for 12 h. For the measurement, the vessel was conditioned in a desiccator over saturated aqueous potassium chloride solution (air humidity about 85%) and at room temperature. Every 2 h, the weight was determined until the weight increase was constant (6-8 h). In the comparison of WVP values, it should be noted that, because of temperature differences between measurements on different days, it is possible to compare only results for samples which have been tested together in the same desiccator at the same time.

Determination of the Swelling of the TPU Films

To determine the intensity of the swelling, water droplets were applied to the flat films and, after a contact time of 10 min, removed again cautiously with an absorptive cloth. The points where the water droplets had been present were then examined as to whether the flat film had lifted off the substrate (significant swelling) or not (slight swelling, if any).

Production of Injection-Moulded TPU Sheets for Measurement of the Mechanical Properties of the TPUs Used

The TPU pellets were melted in an Arburg Allrounder 470 S 1000-290 injection moulding machine (30 mm screw) and shaped to Si specimens (melt temperature about 220° C., mould temperature: 25° C., specimen size: 115×25/6×2 mm).

Measurement of Mechanical Properties

The ultimate tensile strength and elongation at break were determined by measurements in a tensile test to DIN 53504 on Si specimens.

The most important properties of the TPU films or Si specimens thus produced are reported in Tables 2 and 3.

TABLE 2
Water vapour permeability (WVP) and swelling of the TPU films

| | | Film thickness | WVP |
|---|---|---|---|
| TPU | Swelling | [μm] | [g/m²/d] |
| 1* | significant | 60 | 314 |
| 2* | significant | 60 | 275 |
| 3* | none | 100 | 98 |
| 4* | none | 75 | 163 |
| 5* | significant | 50 | 576 |
| 6* | significant | 50 | 372 |
| 7* | significant | 50 | 264 |
| 8 | low | 60 | 234 |
| 9* | moderate to significant | 50 | 228 |
| 12* | significant | 30 | 458 |
| 14* | significant | 40 | 396 |
| 15* | significant | 20 | 539 |
| 16 | low | 25 | 460 |

*comparative examples

The TPUs used once with in according to the invention show good water vapour permeability with simultaneously low swelling (see Table 2).

TABLE 3
Swelling, ultimate tensile strength and elongation at break

| | | Ultimate tensile strength | Elongation at break |
|---|---|---|---|
| TPU | Swelling | [MPa] | [%] |
| 10* | significant | 20.5 | 927 |
| 11 | low | 20.7 | 697 |
| 12* | significant | 15.3 | 793 |
| 13 | low | 18.5 | 970 |
| 14* | significant | 20.6 | 751 |
| 15* | significant | 12.3 | 927 |
| 16 | low | 19.8 | 838 |

*comparative examples

The swelling of the TPUs used in accordance with the invention, in contrast to the comparative examples, is low, with simultaneously adequate ultimate tensile strength and elongation at break (see Table 3).

It was thus possible, by means of specific TPU films based on comparatively inexpensive raw materials having adequate reactivity, to produce composite components having good water vapour permeabilities and adequate mechanical properties, with the simultaneously low swelling of the TPU films used enabling the use thereof in flat composite components.

1. A water vapour-permeable flat composite component comprising:
(i) at least one layer not consisting of thermoplastic polyurethane; and
(ii) at least one layer composed of polyether polyol-based thermoplastic polyurethane, wherein the layer (ii) consists of a thermoplastic polyurethane reaction product of the components consisting of:
A) at least one organic diisocyanate;
B) at least one component having in each case two hydroxyl groups and in each case a number-average molecular weight of 60 to 490 g/mol as chain extender; and
C) a component consisting of one or more polyether polyols each having a number-average molecular weight of 500-5000 g/mol, of which at least one polyether polyol (C1) contains ethylene oxide units;
wherein the molar ratio of NCO groups in A) to isocyanate-reactive groups in B) and C) is 0.9:1 to 1.2:1;
wherein the content of ethylene oxide units in component C) is at least 5% and not more than 42% by weight, based on the total weight of component C), wherein the number-average functionality of component C) is 1.8 to 2.5, and wherein the content of ethylene oxide units (X in % by weight) in component C), relative to the molar ratio Y of chain extenders B) to component C), is below the value of X which arises from the formula X (% by weight)=7.7*Y+7.

2. The flat composite component according to claim 1, wherein the diisocyanate A) is selected from the group consisting of: diphenylmethane 4,4′-diisocyanate, isophorone diisocyanate, hexamethylene 1,6-diisocyanate, naphthylene 1,5-diisocyanate, dicyclohexylmethane 4,4′-diisocyanate, and mixtures of any thereof.

3. The flat composite component according to claim 1, wherein the chain extender B) is at least one aliphatic chain extender having two hydroxyl groups.

4. The flat composite component according to claim 3, wherein the chain extender B) is at least one aliphatic chain extender having two hydroxyl groups and two to eight carbon atoms.

5. The flat composite component according to claim 1, wherein the chain extender B) is at least one compound selected from the group consisting of: ethanediol, propanediol, butanediol, hexanediol, 1,4-di(beta-hydroxyethyl)hydroquinone, 1,4-di(beta-hydroxyethyl)bisphenol A, and mixtures of any thereof.

6. The flat composite component according to claim 1, wherein the chain extender B) is at least two aliphatic chain extenders each having two hydroxyl groups.

7. The flat composite component according to claim 6, wherein the at least two aliphatic chain extenders each have two hydroxyl groups and two to eight carbon atoms.

8. The flat composite component according to claim 1, wherein at least one of the polyether polyols C1) containing ethylene oxide units in component C) is one component or a plurality of components selected from the group consisting of: poly(ethylene glycol), a copolymer of ethylene oxide units and 1,2-propylene oxide units, a copolymer of ethylene oxide units and 1,3-propylene oxide units, a copolymer of ethylene oxide units and 1,3-propylene oxide units and 1,2-propylene oxide units.

9. The flat composite component according to claim 1, wherein component C) is a component mixture selected from the group consisting of: poly(ethylene glycol) and poly(1,2-propylene glycol), of poly(ethylene glycol) and poly(1,3-propylene glycol), of poly(ethylene glycol) and poly(1,3-propylene glycol) and poly(1,2-propylene glycol), poly(ethylene glycol) and a polyol formed from ethylene oxide units and from propylene oxide units, of poly(1,2-propylene glycol) and a polyol formed from ethylene oxide units and from propylene oxide units, of poly(1,3-propylene glycol) and a polyol formed from ethylene oxide units and from propylene oxide units, of poly(ethylene glycol) and poly(1,2-propylene glycol) and a polyol formed from ethylene oxide units and from propylene oxide units, of poly(ethylene glycol) and poly(1,3-propylene glycol) and a polyol formed from ethylene oxide units and from propylene oxide units, of poly(ethylene glycol) and poly(1,3-propylene glycol) and poly(1,2-propylene glycol) and a polyol formed from ethylene oxide units and from propylene oxide units.

10. The flat composite component according to claim 1, wherein the content of ethylene oxide units in component C) is at least 5 and not more than 35% by weight, based on the total weight of component C).

11. The flat composite component according to claim 1, wherein at least one of the polyether polyols C1) containing ethylene oxide units in component C) is formed from ethylene oxide units and from propylene oxide units and contains 1% to 75% primary hydroxyl end groups.

12. The flat composite component according to claim 1, wherein at least one of the polyether polyols C1) containing ethylene oxide units in component C) is formed from 30% to 99% by weight of ethylene oxide units and from 1% to 70% by weight of propylene oxide units.

13. The flat composite component according to claim 1, wherein component C) does not contain any poly(tetramethylene glycol).

14. A roofing underlayment or an exterior underlayment comprising the flat composite component according to claim 1.

15. The flat composite component according to claim 1, wherein the reaction is conducted in the presence of:
D) catalysts.

16. The flat composite component according to claim 1, wherein the reaction is conducted in the presence of:
E) assistants and/or additives.

17. The flat composite component according to claim 1, wherein the water vapour-permeable flat composite component comprises:
(iii) further layers composed of thermoplastic polyurethane that do not directly adjoin the layer (ii) with a flat join.
